(19) United States
(12) Patent Application Publication
(10) Pub. No.: US 2002/0076039 A1
(43) Pub. Date: Jun. 20, 2002

(54) Method and apparatus for securing telephone passwords

(76) Inventor: Bruce Levens, Wayland, MA (US)

Correspondence Address: Brett N. Dorny, Mintz, Levin, Cohn, Ferris,, Glovsky and Popeo, P.C., One Financial Center, Boston, MA, 02111, US

(21) Appl. No.: 09/742,041

(22) Filed: Dec. 20, 2000

(51) Int. Cl. H04M 3/00

(52) U.S. Cl. 379/418

(57) ABSTRACT

DTMF tones used to enter a password reflected by an answering machine or voice mail system can be masked using a jamming signal generator. When an answering machine or voice mail system is accessed with a cellular phone, the DTMF tones used for the password can be reflected back over the cellular network, which compromises security. A method and apparatus are disclosed which detects tones on an input line and outputs a jamming signal on the output line to mask the reflected tones.

### BACKGROUND OF THE INVENTION

1. Field of the Invention

The present invention relates to a system for securing passwords entered using DTMF tones. In particular, it relates to a system which detects DTMF tones and generates a jamming signal on the returning lines to prevent tone bounce back.

2. Discussion of the Prior Art

When answering machines and voicemail systems are accessed through the telephone lines, a password is typically required. The password is entered using the keypad of the remote telephone, which generates dual tone multiple frequency (DTMF) tones. Generally, the DTMF or touch tones can reflect off the mismatch at the answering machine or voicemail system. An eavesdropper on the outgoing line can discover the password by recording the reflected tones. The widespread use of cellular telephones increases the problem. Using relatively unsophisticated devices, such as a modified scanner and tape recorder, the tones reflected from the answering machine or voice mail system can be discovered from the cellular transmission. The reflected tones are broadcast over the cellular link as audio, where they are easily intercepted. Even with cellular encryption, the reflected tones produce a type of known plaintext, which can be decoded. The reflection of tones within the telephone system, particularly when coupled with a cellular system compromises security of a answering machine or voice mail system. Accordingly, a need exists for a system which prevents access to reflected tones when passwords are entered.

### SUMMARY OF THE INVENTION

The present invention overcomes the deficiencies of the prior art by providing a jamming signal generator to mask the reflected DTMF tones. According to an embodiment of the present invention, a system is provided with an answering machine which detects DTMF tones on the incoming telephone line and generates a jamming signal on the outgoing line. The jamming signal, such as a noise pattern, masks the reflected tones. The jamming signal is triggered by detection of a first DTMF tone and terminates after detection of a last tone.

### BRIEF DESCRIPTION OF THE DRAWING

FIG. 1 illustrates an embodiment of the present invention in connection with an answering machine on a telephone system including a cellular network.

### DETAILED DESCRIPTION OF THE PREFERRED EMBODIMENT

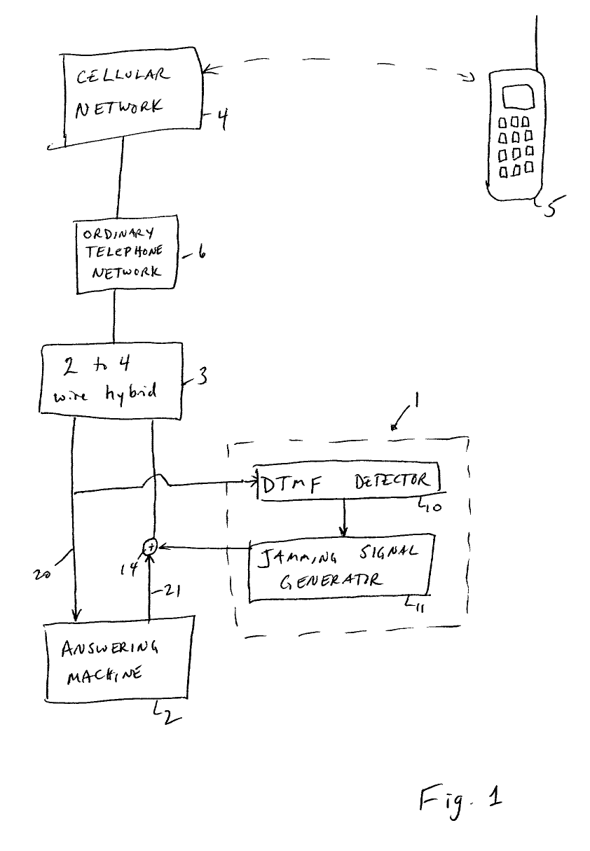

The system 1 of the present invention is illustrated in FIG. 1. The system 1 includes a DTMF detector 10 and a jamming signal generator 11. The DTMF detector 10 detects the occurrence of DTMF tones. The jamming signal generator 11 creates a masking noise pattern. The masking noise pattern may consist of a rapidly changing DTMF tones or any other pattern which can interfere with detection of DTMF tones. The system 1 is connected to the wires from the 2 to 4 wire hybrid 3 of the telephone system and an answering machine 2. Of course, the answering machine 2 can be replaced by any other type of telephone equipment, such as a voicemail system, a computer modem, or other telephone interface. A user calls the answering machine 2 from a cellular telephone 5. The call passes through the cellular network 4 and ordinary telephone network 6 through the 2 to 4 wire hybrid 3 to the answering machine 2. As is typical for remotely accessed answering machines, the user then has to input a password using the keypad of the cellular telephone 5. The password is transmitted as DTMF tones through the ordinary telephone network 6. The DTMF tones transmitted to the answering machine on the input 20 are reflected on the output 21. Without the system 1 of the present invention, the reflected DTMF tones are passed to the cellular network 4 where they are transmitted as audio. The system 1 of the present invention connects to the input 20 and output 21 lines of the answering machine. The DTMF detector 10 detects DTMF tones on the input 20 using known techniques. When DTMF tones are detected, the jamming signal generator 11 commences operation. The jamming signal generator 11 should stop operation after the entry of the password is complete. This can be done in various manners. For example jamming can stop after a specified hold time, after detection of a specified number of digits, or upon detection of voice on the input line. The masking noise pattern is added 14 to the output 21 to mask the reflected DTMF tones. A masking pattern could be used with the cellular phone 5, if the cellular phone 5 transmits DTMF tones. Since the masking noise pattern would be known, the answering machine can subtract out the pattern to determine the DTMF tones, if necessary.

Of course, other methods and devices could be used to detect the DTMF tones and to generate a jamming signal. Additionally, the system of the present invention can be used with any devices which receive DTMF tones and can reflect those tones to prevent unauthorized interception of the reflected tones. Furthermore, those of ordinary skill in the art will recognize that adaptations and modifications can be made to the embodiment without departing from the essential characteristics of the present invention. The scope of the invention is not limited by the embodiments disclosed, includes adaptations and modifications, and is only limited by the appended claims.

I claim:

1. A system for masking tones reflected by telephone equipment having an input and an output, the system comprising:
a detector connected to the input for determining when a tone has been received by the telephone equipment on the input; and
a jamming signal generator connected to the output for outputting a masking pattern on the output when the detector determines that a tone has been received.

2. The system of claim 1 further comprising a signal adder combining the output of the telephone equipment and the masking pattern from the jamming signal generator.

3. The system of claim 1 wherein the masking pattern is a known pattern of rapidly changing tones.

4. The system of claim 1 wherein the tones are DTMF tones.

5. A method for masking tones reflected by telephone equipment having an input and an output, the method comprising the steps of:
detecting a tone on the input of the telephone equipment; and
generating a masking pattern on the output of the telephone equipment a tone is received.

6. The method of claim 5 wherein the masking pattern is a known pattern of rapidly changing tones.

7. The method of claim 5 wherein the tones are DTMF tones. embodiments disclosed, includes adaptations and modifications, and is only limited by the appended claims.
